(19) United States
(12) Patent Application Publication
(10) Pub. No.: US 2014/0322005 A1
(43) Pub. Date: Oct. 30, 2014

(54) EXHAUST GAS TURBOCHARGER

(71) Applicant: IHI CHARGING SYSTEMS INTERNATIONAL GMBH, Heidelberg (DE)

(72) Inventors: Thomas IHLI, Ilvesheim (DE); Roberto DE SANTIS, Sulzbach (DE)

(21) Appl. No.: 14/324,196

(22) Filed: Jul. 6, 2014

Related U.S. Application Data
(63) Continuation-in-part of application No. PCT/EP2013/000021, filed on Jan. 8, 2013.

(30) Foreign Application Priority Data
Jan. 18, 2012 (DE) 10 2012 006 711.9

(51) Int. Cl. F02B 47/08

(52) U.S. Cl. CPC F02B 47/08
USPC 415/208.1

(57) ABSTRACT

In an exhaust gas turbocharger with a casing part in which a guide apparatus comprising two axially spaced insert elements forming a flow duct is arranged with guide vanes supported on at least one of the insert elements via which exhaust gas flowing through the flow duct is guided into the turbine of the turbocharger and wherein a first of the insert elements comprises a first wall portion which extends at least essentially in the radial direction and an adjoining second wall portion which extends essentially in the axial direction so as to form a corner area of the first insert element, wherein in the first wall portion and/or in the corner area in a side facing the casing part at least one recess is provided.

This is a Continuation-In-Part application of pending international patent application PCT/EP2013/000021 filed 2013 Jan. 8 and claiming the priority of German patent application 10 2012 005 711.9 filed 2012 Jan. 18.

### BACKGROUND OF THE INVENTION

The invention relates to an exhaust gas turbocharger which includes a turbine with a casing with a guide structure having two insert elements arranged in the casing in axially spaced relationship and guide vanes supported on at least one of the inserts elements.

EP 2 348 195 A2 discloses an exhaust gas turbocharger with a turbine comprising a turbine casing and with a bearing housing. The exhaust gas turbocharger additionally comprises a guide apparatus with two insert elements formed separately from the turbine casing and the bearing housing. One of the insert elements is a carrier element. The other one of the insert elements is a shroud element. The insert elements are spaced from each other in the axial direction of the exhaust gas turbocharger so as to form a flow duct between the insert elements. Guide vanes of the guide apparatus are movably supported relative to the insert elements on at least one of the insert elements. Exhaust gas which flows through the flow duct is guided by means of the guide vanes. The insert element which is arranged closer to a turbine outlet comprises a first wall portion which extends at least essentially in the radial direction and a second adjoining wall portion which extends at least essentially in the axial direction. The wall portions jointly form a corner area of the insert element. The second wall portion comprises a circumferential groove in which a seal element is accommodated.

WO 2007/046798 A1, too, discloses such an exhaust gas turbocharger. The insert element of the exhaust gas turbocharger, which is allocated closer to the turbine outlet also comprises two grooves in its second wall portion, in which respective seal elements are arranged,

It was found that during the operation of the exhaust gas turbocharger, while hot exhaust gas flows through the turbine, thermally induced deformations in particular of the turbine casing and the guide apparatus occur. In order to avoid jamming and/or other malfunctions of the movable guide vanes relatively large so-called function gaps are provided between the guide vanes and the insert elements. However, the exhaust gas may flow past the guide vanes via the relatively large function gaps so that some of the exhaust gas is not utilized. Consequently, the exhaust gas may flow undirected into a turbine wheel of the turbine. This affects the efficient operation of the exhaust gas turbocharger.

It is therefore the object of the present invention to provide an exhaust gas turbocharger of the above mentioned type in such a manner that the exhaust gas turbocharger operates in a more efficient manner.

### SUMMARY OF THE INVENTION

In an exhaust gas turbocharger with a casing part in which a guide apparatus comprising two axially spaced insert elements forming a flow duct is arranged with guide vanes supported on at least one of the insert elements via which exhaust gas flowing through the flow duct is guided into the turbine of the turbocharger and wherein a first of the insert elements comprises a first wall portion which extends at least essentially in the radial direction and an adjoining second wall portion which extends essentially in the axial direction so as to form a corner area with the first insert element, a recess is provided at least in one of the first wall portion and the corner area at a side facing the casing part.

In order to avoid or minimize thermally induced deformations of the first insert element during the operation of the exhaust gas turbocharger while hot exhaust gas flows through the flow duct, the invention provides for at least one recess in the first wall portion and/or in the corner area in a side facing the casing part. Thus, the first insert element is correspondingly adapted with respect o its geometry or its outer contour, respectively, to being subjected to high temperatures during the operation of the exhaust gas turbocharger so that the first insert element is not or only negligibly deformed. The risk of jamming and/or other malfunctions of the guide vanes which are movable relative to the insert elements is therefore avoided or minimized. Function gaps between the guide vanes and the insert elements may be kept very small so that the exhaust gas flowing through the flow duct may not flow past the guide vanes or only in very small quantities and flow undirected into a turbine wheel of a turbine of the exhaust gas turbocharger.

In other words, at least essentially the entire exhaust gas flowing through the flow duct may be aerodynamically efficiently guided or diverted, respectively, by means of the guide vanes so as to flow into the turbine wheel under an angle which ensures favorable flow and energy transfer characteristics. This results in an efficient operation with a high efficiency of the exhaust gas turbocharger. In particular, a reciprocating combustion engine of an automobile may be efficiently charged by the exhaust gas turbocharger, which results in low fuel consumption and thus low CO₂ emission.

The recess comprises a bottom area which is offset from the casing part relative to a first surface of a first wall portion, adjacent one side of the recess, and relative to a second surface of a second wall portion of the first insert element adjacent the other side of the recess. In other words, the recess is defined at least at three sides. The recess may be formed e. g. as a groove the corners of which may be rounded.

By means of the groove, the wall thickness of the first insert element in the first wall portion and/or in the corner area is locally reduced, which results in a relatively high flexibility of the first insert element, in particular compared to a first insert element without such a recess or recesses. Thereby, deformations of the first insert element during the operation of the exhaust gas turbocharger may at least be kept small.

Preferably, the first insert element comprises the at least one recess in the first wall portion as well as at least a second recess in the corner area. This brings about a particularly small deformation of the insert element, which is beneficial both for the functional reliability and the efficient operation of the inventive exhaust gas turbocharger.

In an advantageous embodiment, a sealing element which, on the one hand, is supported at the casing part and, on the other hand, at the first insert element, is arranged in the recess by means of which the first insert element is sealed against the casing part. Thereby, a high functional integration is achieved, where the recess does not only provide for an advantageous deformation behavior of the first insert element but also serves to accommodate and secure the sealing element. This keeps the costs of the inventive exhaust gas turbocharger within a narrow range.

In another embodiment of the invention, the casing part is a turbine casing of the turbine of the exhaust gas turbocharger. In particular, the turbine casing is subjected to very high temperatures during the operation of the exhaust gas turbocharger because the exhaust gas of the combustion engine flowing through it. Because the first insert element is arranged particularly close to the turbine casing the risk of a very high temperature application of the first insert element to the turbine casing is relatively high if no appropriate countermeasures are taken. The at least one recess keeps thermally induced deformations of the first insert element at least small so that the space between the turbine casing and the first insert element is maintained.

The exhaust gas turbocharger may also comprise a bearing housing which is connected to the turbine casing and in which a rotor of the exhaust gas turbo-charger is supported. The rotor comprises the turbine wheel and a shaft at which the turbine wheel is rotationally fixed.

The exhaust gas turbocharger may further comprise a compressor with a compressor casing in which a compressor wheel is arranged. The compressor wheel is also associated with the rotor and connected rotationally fixed to the shaft. The rotor is rotatable about an axis of rotation relative to the bearing housing, relative to the compressor casing and relative to the turbine casing. The compressor wheel is driven via the turbine wheel due to the rotationally fixed connections and compresses air to be supplied to the combustion engine.

Preferably, the wall of the casing part is shaped so as to accommodate the first insert element. Thereby, an advantageous sealing between the first insert element and the casing part may be realized.

Preferably, the guide apparatus is exclusively secured via one of the insert elements, in particular exclusively via the second insert element, at a casing part, in particular at the bearing housing, of the exhaust gas turbocharger. This attachment of the guide apparatus limits the temperature application on the guide vane control apparatus due to the heat transfer to the guide vane control apparatus so that thermally induced deformations of the entire guide apparatus may be kept small. This allows the provision of only small function gaps between the guide vanes and the insert elements, which results in a particularly efficient operation of the exhaust gas turbocharger.

Preferably, the insert elements are interconnected by at least one connecting element. The connecting element may be formed separately from the insert elements which facilitates assembly of the guide apparatus. The insert element which is not attached at a casing part of the exhaust gas turbocharger is connected to the insert element which is attached at a casing part of the exhaust gas turbocharger via the connecting element. Thus, the guide apparatus may be securely held in place and precisely aligned relative to the casing part or to the casing parts of the exhaust gas turbocharger, respectively.

As noted earlier, the first insert element is spaced relative to the casing part so as to reduce the heat transfer to the casing part and thermally induced deformations of the housing part.

Preferably, the entire guide apparatus is spaced relative to the casing part, in particular from all casing parts, of the exhaust gas turbocharger. This results in a relative homogeneous temperature distribution in the guide apparatus due to a very low heat transfer to the casing part or the casing parts, respectively, which keeps the thermally induced deformation of the guide apparatus very small. Thereby, very small function gaps may be implemented, which results in a particularly efficient and thus in an operation with a high efficiency ratio of the exhaust gas turbocharger.

The invention will become more readily apparent from the following description of preferred exemplary embodiments with references to the accompanying drawings. The features and feature combinations as previously mentioned in the description as well as the features and feature combinations which will be indicated in the following description of the figures and/or which are solely illustrated in the figures are not only applicable in the respective indicated combination but also in other combinations or isolated, without deviating from the scope of the invention.

### BRIEF DESCRIPTION OF THE DRAWINGS

FIG. 1 shows portions of a schematic longitudinal sectional view of a turbine of an exhaust gas turbocharger with a turbine casing in which a guide apparatus for deflecting the exhaust gas flowing through the turbine casing is arranged; and

FIG. 2 shows portions of a schematic longitudinal sectional view of another embodiment of the turbine according to FIG. 1.

### DESCRIPTION OF EXEMPLARY EMBODIMENTS

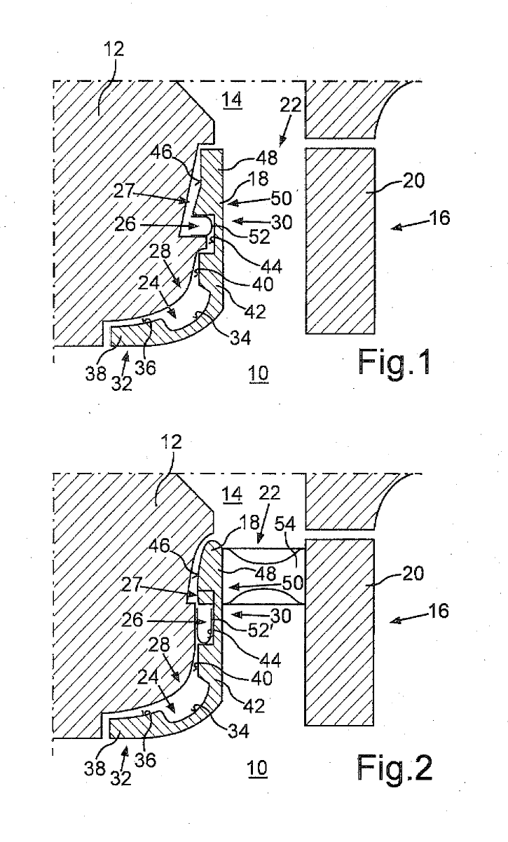

FIG. 1 is a sectional view of part of a turbine 10 housing of an exhaust gas turbocharger for a combustion engine which is e. g. configured as a reciprocating combustion engine. The turbine 10 comprises a turbine casing 12 which has at least one supply duct 14. The turbine casing 12 further comprises a housing space in which a turbine wheel of the turbine 10 is at least partially accommodated rotatable about an axis of rotation relative to the turbine casing 12.

The exhaust gas turbocharger further comprises a bearing housing (not shown in FIG. 1) adjoining the turbine casing 12 in the axial direction of the exhaust gas turbocharger and being connected with the turbine casing 12. A rotor of the exhaust gas turbocharger is supported on the bearing housing and is rotatable about the axis of rotation relative to the bearing housing. The rotor comprises a shaft with which the turbine wheel is torque proof connected.

The exhaust gas turbocharger further comprises a compressor with a compressor casing adjoining the bearing housing in the axial direction of the exhaust gas turbocharger and connected with it. The compressor casing comprises another housing space in which a compressor wheel of the compressor is at least partially accommodated rotatable about the axis of rotation relative to the compressor casing. The compressor wheel is also allocated to the rotor and torque proof connected with the shaft. The compressor wheel may be driven by the turbine wheel via the torque proof connections and compress air to be supplied to the combustion engine. Thus, the combustion engine may be supplied with compressed air and efficiently driven, which results in only low fuel consumption and consequently low CO₂ emission.

The exhaust gas turbocharger also comprises a guide apparatus 16 which is accommodated in the turbine casing 12. The guide apparatus 16 comprises a first guide element which is referred to as shroud element 18. The guide apparatus 16 further comprises a second insert element which is referred to as carrier element 20. As can be seen in FIG. 1, the shroud element 18 and the carrier element 20 are disposed spaced from each other in the axial direction of the turbine 10 so as to form a flow duct 22 between the shroud element 18 and the carrier element 20. In other words, the shroud element 18 and the carrier element 20 define the width of the flow duct 22 in the axial direction. The shroud element 18 is mounted to the carrier element 20 preferably by bolts which are not shown in FIG. 1.

The shroud element 18 is also referred to as counter contour element or contour element because it comprises at least partially a counter contour which at least essentially corresponds to an outer contour of the turbine wheel.

The supply duct 14 extends e. g. in the circumferential direction of the turbine wheel over its circumference at least essentially helically and is fluidly connected with at least one combustion chamber, in particular a cylinder, of the combustion engine. Thereby, exhaust gas of the combustion engine may flow from the combustion chamber into the supply duct 14.

The supply duct 14 is fluidly connected with the flow duct 22 so that the exhaust gas may flow from the supply duct 14 into the flow duct 22. The flow duct 22 opens into the housing space for the turbine wheel so that the exhaust gas flowing through the flow duct 22 may flow into the turbine wheel and drive it.

The guide apparatus 16 also comprises guide vanes (not shown. FIG. 1) which are disposed in the flow duct 22 and which are arranged distributed in the circumferential direction of the turbine wheel over its circumference. The guide vanes serve for guiding the exhaust gas flowing through the flow duct 22 so that the exhaust gas flows into the turbine wheel under at least an aerodynamically suitable flow angle. Thereby, the turbine wheel is efficiently driven by the exhaust gas,

The guide vanes (not shown in FIG. 1) are exclusively supported at the carrier element 20 rotatable about respective axes of rotation relative to the shroud element 18 and relative to the carrier element 20. By rotating the guide vanes relative to the shroud element 18 and relative to the carrier element 20 the turbine 10 may be adapted to different exhaust gas mass flows. Thereby, the turbine 10 may be efficiently driven both at low exhaust gas mass flows and higher exhaust gas mass flows. The guide vanes which are movable or rotatable, respectively, relative to the shroud element 18 and relative to the carrier element 20 form a variable turbine geometry of the turbine 10 so that it may be adapted to different operation points of the combustion engine as required.

During the operation of the exhaust gas turbocharger when hot exhaust gas flows through the turbine casing 12, the guide apparatus 16 and in particular the shroud element 18 are subjected to high temperatures. This results in thermally induced deformations in particular of the shroud element 18. In order to avoid jamming and/or other malfunctions of the guide vanes, respective function gaps are provided between the guide vanes and the shroud element 18 and between the guide vanes and the carrier element 20.

In order to achieve only very small thermally induced deformations of the guide apparatus 16 so that the function gaps may be kept particularly small, the shroud element 18 comprises a first recess 24 as well as a second recess 26 in a side 27 facing the turbine casing 12 and facing away from the flow duct 22 of the shroud element 18.

As can be seen in FIG. 1, the first recess 24 is arranged in a corner area 28 of the shroud element 18. The present rounded corner area 28 is formed by a first wall portion 30 extending at least essentially in the radial direction and an adjoining second wall portion 32 of the shroud element 18, which extends at least essentially in the axial direction. The second recess 26 is arranged in the first wall portion 30. The recesses 24, 26 are formed at least essentially groove-shaped or groove-like, respectively, and are defined on three sides. The first recess 24 comprises a first bottom area 34 which is offset from the turbine casing 12 relative to a first surface 36 of a first wall portion 38 with the adjoining first recess 24 as well as relative to a second surface 40 of a second wall portion 42 of the shroud element 18 adjoining the first recess 24. Analogously, a second bottom 44 of the second recess 26 is offset from the turbine casing 12 relative to the second surface 40 of the second wall portion 42 with the adjoining second recess 26 and relative to a third surface 46 of the second recess 26 adjoining the third wall portion 48 of the shroud element 18. By means of the recesses 24, 26, the wall thickness of the shroud element 18 is reduced compared to the respective wall portions 38, 42, 48 adjoining the recesses 24, 26.

On another side 50 facing away from side 27 on which the shroud element 18 at least partially defines the flow duct 22, the shroud element 18 is formed at least essentially plain or smooth, i. e. the shroud element 18 has no recess on the other side 50. This provides for an aerodynamically suitable routing of the exhaust gas flowing through the flow duct 22.

As can also be seen in FIG. 1, the shroud element 18 is completely spaced from the turbine casing 12. This means that the shroud element 18 does not contact the turbine casing 12. In order to prevent exhaust gas from flowing of the upstream of the turbine wheel through the gap between the turbine casing 12 and the shroud element 18, a sealing element 52 in the form of a V-ring seal is provided. The sealing element 52 could as well be a U-seal. The sealing element 52 is supported at the turbine casing 12, on the one hand, and at the shroud element 18, on the other hand.

The turbine casing 12 partially protrudes into the second recess 26. The sealing element 52 is at least partially supported on the part of the turbine casing 12 which protrudes into the second recess 26.

FIG. 2 shows another embodiment of the turbine 10 according to FIG. 1. The attachment of the guide apparatus 16 at the turbine casing 12 is explained with reference to FIG. 2. The guide apparatus 16 is preferably attached at the turbine casing 12 exclusively via the carrier element 20 which is attached at the turbine casing 12. This means that the shroud element 18 is not attached at the turbine casing 12, and not at the bearing housing and not at the compressor casing. The carrier element 20 is attached at the turbine casing 12, but not at the bearing housing and not at the compressor casing. The shroud element 18 is held to the carrier element 20 via at least one connecting element 54, which in the present case is a bolt. Attachment and securing in position of the shroud element 18 relative to the turbine casing 12 or to all casing parts, respectively, of the exhaust gas turbocharger are thus effected via the carrier element 20, which is secured in position due to its attachment to the turbine casing 12 relative to all casing parts of the exhaust gas turbocharger. Here the gap between the turbine casing 12 and the shroud element 18 is sealed by a sealing element 52′ which axially engages the turbine casing 12 and the shroud element 18.

What is claimed is:

1. An exhaust gas turbocharger including a turbine with a casing part (12), a guide apparatus (16), which is formed separately from the casing part (12) supported on the casing part (12) and comprising first and second insert elements (18, 20) which are spaced from each other in an axial direction so as to form a flow duct (22) between the insert elements (18, 20) with guide vanes of the guide apparatus (16) supported on at least one of the first and second insert elements (18, 20) so as to be movable relative to the insert elements (18, 20) for controlling exhaust gas flowing through the flow duct (22), at least the first insert element (18) comprising at least a first wall portion (30) which extends at least essentially in the radial direction and at least one adjoining second wall portion (32) which extends at least essentially in the axial direction, so as to form a corner area (28) of the first insert element (18), the first wall portion (30) and in the corner area (28), the first insert element (18) having at a side (27) thereof facing the casing part (12) at least a first recess (24) and a second recess (26) providing for reduced wall thickness areas of the first insert element (18).

2. The exhaust gas turbocharger according to claim 1, wherein in at least one of the first recess (24) and the second recess (26) a sealing element (52) is arranged which is supported on the one hand on the casing part (12) and on the other hand on the first insert element (18), so that the first insert element (18) is sealed against the casing part (12).

3. The exhaust gas turbocharger according to claim 1, wherein the casing part (12) is a turbine casing (12) of a turbine (10) of the exhaust gas turbocharger.

4. The exhaust gas turbocharger according to claim 1, wherein the guide vanes are only supported on the second insert element (20).

5. The exhaust gas turbocharger according to claim 1, wherein the casing part (12) is shaped so as to accommodate the first insert element (18).

6. The exhaust gas turbocharger according to claim 1, wherein the guide apparatus (16) is exclusively attached via the second insert element (20) at a bearing housing of the exhaust gas turbocharger.

7. The exhaust gas turbocharger according to claim 6, wherein the insert elements (18, 20) are connected with each other by means of at least one connecting element (54).

8. The exhaust gas turbocharger according to claim 1, wherein the first insert element (18) is spaced from the casing part (12).

9. The exhaust gas turbocharger according to claim 8, wherein the guide apparatus (16) is spaced from the casing part (12) of the exhaust gas turbocharger.
